(19) United States
(12) Patent Application Publication
(10) Pub. No.: US 2026/0109207 A1
(43) Pub. Date: Apr. 23, 2026

(54) VEHICLE BODY PANEL

(71) Applicant: TOYOTA JIDOSHA KABUSHIKI KAISHA, Toyota-shi Aichi-ken (JP)

(72) Inventors: Tatsuya SHIMIZU, Okazaki-shi Aichi-ken (JP); Hiroki HYODO, Toyota-shi Aichi-ken (JP); Takato YAMADA, Toyota-shi Aichi-ken (JP)

(73) Assignee: TOYOTA JIDOSHA KABUSHIKI KAISHA, Toyota-shi Aichi-ken (JP)

(21) Appl. No.: 19/360,013

(22) Filed: Oct. 16, 2025

(30) Foreign Application Priority Data
Oct. 21, 2024 (JP) 2024-185277
Oct. 29, 2024 (JP) 2024-190039

(51) Int. Cl. B60J 5/04; E05B 85/02

(52) U.S. Cl. CPC B60J 5/0469; B60J 5/0415; B60J 5/048; E05B 85/02

(57) ABSTRACT

A vehicle body panel includes a front door frame made of metal, a front door outer panel made of resin attached to an outer side of the front door frame, and a protector covering a bolt for fastening the front door outer panel to the front door frame. The protector is provided on the front door outer panel, penetrates the front door frame, protrudes to the inner side of the front door frame, and covers the upper side of the bolt on the inner side of the front door frame.

### CROSS REFERENCE TO RELATED APPLICATION

This application claims priority to Japanese Patent Application No. 2024-190039 filed on Oct. 29, 2024, and No. 2024-185277 filed on Oct. 21, 2024, each of which is incorporated herein by reference in its entirety including the specification, claims, drawings, and abstract.

### TECHNICAL FIELD

The present disclosure relates to a vehicle body panel including a resin outer panel and a frame made of metal.

### BACKGROUND

JP2024-14869A, JP2024-14819A discloses an anti-theft device for preventing theft of a vehicle by covering a connector connected to an electronic control unit of the vehicle and preventing removal of the connector.

### SUMMARY

In recent years, a vehicle body panel in which a resin outer panel is attached to a frame made of metal has been used. The outer panel is attached to the frame with bolts/nuts, clips, or the like to facilitate attachment and detachment. Therefore, there is a possibility that the outer panel may be removed or the vehicle may be stolen.

Accordingly, an object of the present disclosure is to make it difficult to access a fastening member that fastens an outer panel made of resin to a frame with a simple configuration.

A vehicle body panel according to an embodiment of the present disclosure includes a frame made of metal, an outer panel made of resin and attached to an outer side of the frame, a fastening member that fastens the outer panel to the frame, and a protector that covers at least a part of the fastening member, wherein the protector is provided on the outer panel, passes through the frame to protrude from an inner side of the frame, and covers, at the inner side of the frame, at least a part of the fastening member.

In this way, since the protector covers the fastening member, access to the fastening member can be made difficult.

In the vehicle body panel of the present disclosure, the outer panel may include a bracket fastened to the frame by the fastening member, the protector may protrude from the bracket toward the frame, and the frame may include a hole through which the protector passes.

Accordingly, since the protector can be disposed in the vicinity of the fastening member, access to the fastening member can be made more difficult.

In the vehicle body panel of the present disclosure, the bracket and the protector may be integrally molded with the outer panel.

This makes it difficult to access the fastening member with a simple configuration. In the vehicle body panel of the present disclosure, the frame may be a door frame, the outer panel may be a door outer panel, the vehicle outer panel structure further may comprise a door lock mechanism disposed in a space between the door frame and the door outer panel, and the door outer panel may have a lock protector that extends from a surface facing the door frame toward the door frame and may cover at least a part of the door lock mechanism.

This makes it difficult to access the door lock mechanism.

In the vehicle body panel of the present disclosure, the door frame may include a flange protruding toward the door outer panel from a surface facing the door outer panel and configured to support an end portion of the lock protector.

As a result, the lock protector is less likely to deform, and access to the lock mechanism can be made more difficult.

A vehicle body panel according to an embodiment of the present disclosure includes a door frame made of metal, a door outer panel made of resin and attached to an outer side of the door frame, and a door lock mechanism disposed in a space between the door frame and the door outer panel, wherein the door outer panel has a lock protector that extends from a surface facing the door frame toward the door frame and covers at least a part of the door lock mechanism.

This makes it difficult to access the door lock mechanism.

According to the present disclosure, access to the fastening member for fastening the resin outer panel to the frame can be made difficult with a simple configuration.

### BRIEF DESCRIPTION OF DRAWINGS

FIG. 1 is a side view of a vehicle including a vehicle body panel according to an embodiment of the present disclosure.

FIG. 2 is a cross-sectional view of the vehicle body panel according to the embodiment taken along line A-A of FIG. 1;

FIG. 3 is a cross-sectional view of the vehicle body panel according to the embodiment, and is a cross-sectional view taken along line B-B in FIG. 1;

FIG. 4 is a side view of a vehicle including a vehicle body panel according to another embodiment.

FIG. 5 is a cross-sectional view of a vehicle body panel according to another embodiment, and is a cross-sectional view taken along line C-C in FIG. 4;

FIG. 6 is a cross-sectional view of a vehicle body panel according to another embodiment, and is a cross-sectional view taken along line D-D in FIG. 4;

FIG. 7 is a rear view of a vehicle including a vehicle body panel according to another embodiment;

FIG. 8 is a cross-sectional view of a vehicle body panel according to another embodiment, and is a cross-sectional view taken along line E-E in FIG. 7;

FIG. 9 is a rear view of a vehicle including a vehicle body panel according to another embodiment.

### DESCRIPTION OF EMBODIMENTS

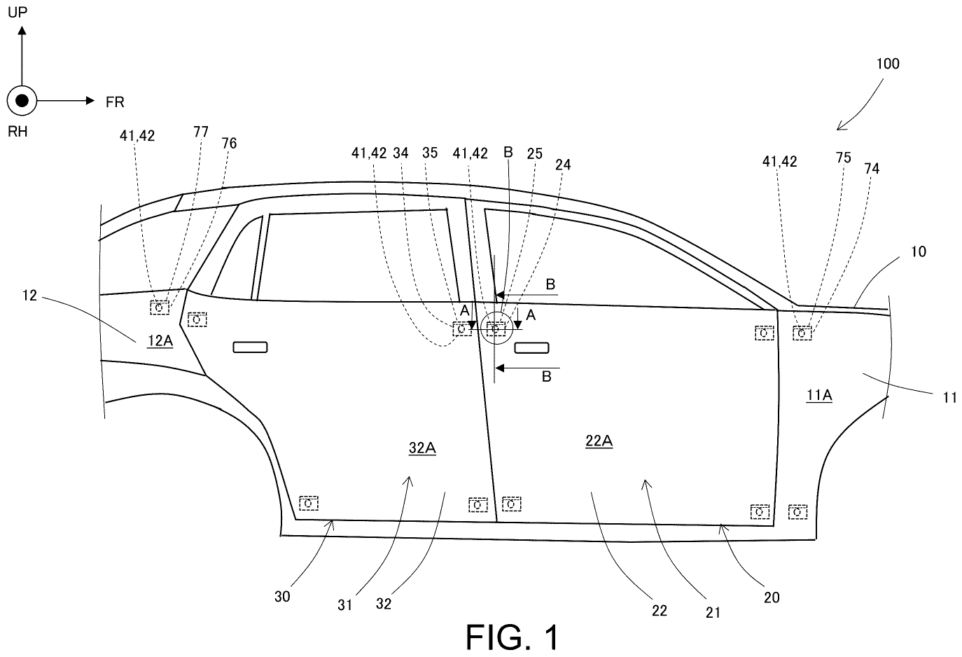

Hereinafter, a vehicle body panel according to an embodiment will be described with reference to the drawings. In the following description, the configurations of the front door 20 and the rear door 30 of the vehicle 100 will be described as an example of the vehicle body panel. FIG. 1 is a right side view of a vehicle 100 including a front door 20 according to an embodiment. Note that FR, UP, and RH shown in the drawings indicate the front side, the upper side, and the right side of the vehicle 100, respectively. The opposite directions of FR, UP, and RH indicate the rear side, the lower side, and the left side, respectively. Hereinafter, in the case where the front-rear direction, the left-right direction, and the up-down direction are simply used, the front-rear direction, the left-right direction, and the up-down direction of the vehicle 100 are indicated unless otherwise specified.

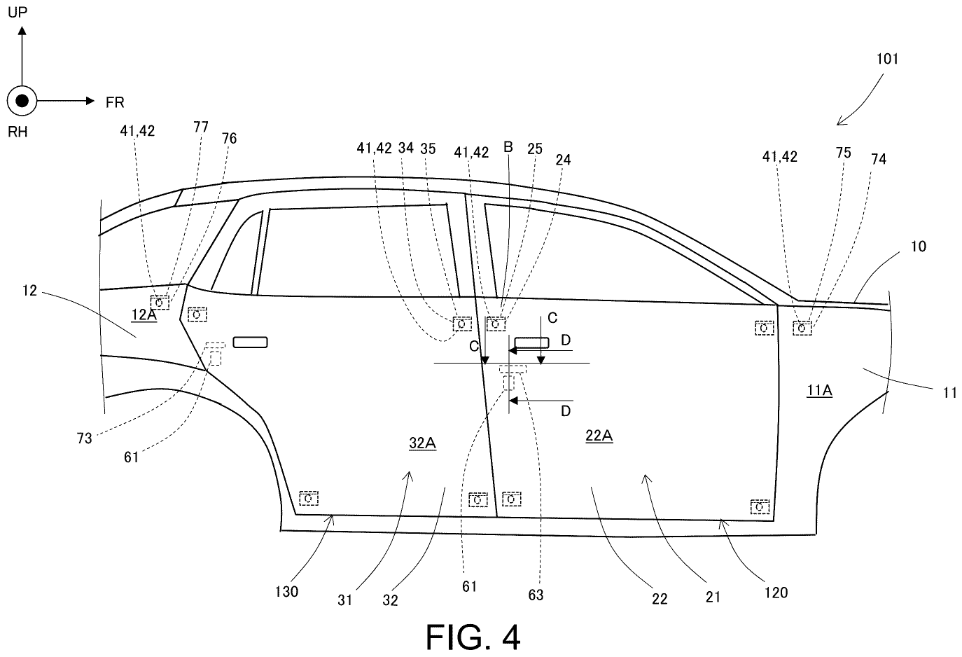

First, the configuration of the vehicle 100 will be described. As shown in FIGS. 1 and 4, the vehicle 100 includes a body 10, a front door 20, and a rear door 30. The body 10 is configured by attaching outer panels such as a front fender panel 11 made of resin and a rear fender panel 12 made of resin to the outside of a frame made of metal (not shown). The front fender panel 11 and the rear fender panel 12 are attached to the frame by bolt 41 and nuts 42. The outer surface 11A of the front fender panel 11 constitutes a design surface of the front fender panel 11, and the outer surface 12A of the rear fender panel 12 constitutes a design surface of the rear fender panel 12. The frame made of metal may be a folded plate member, or may be a cast metal such as aluminum.

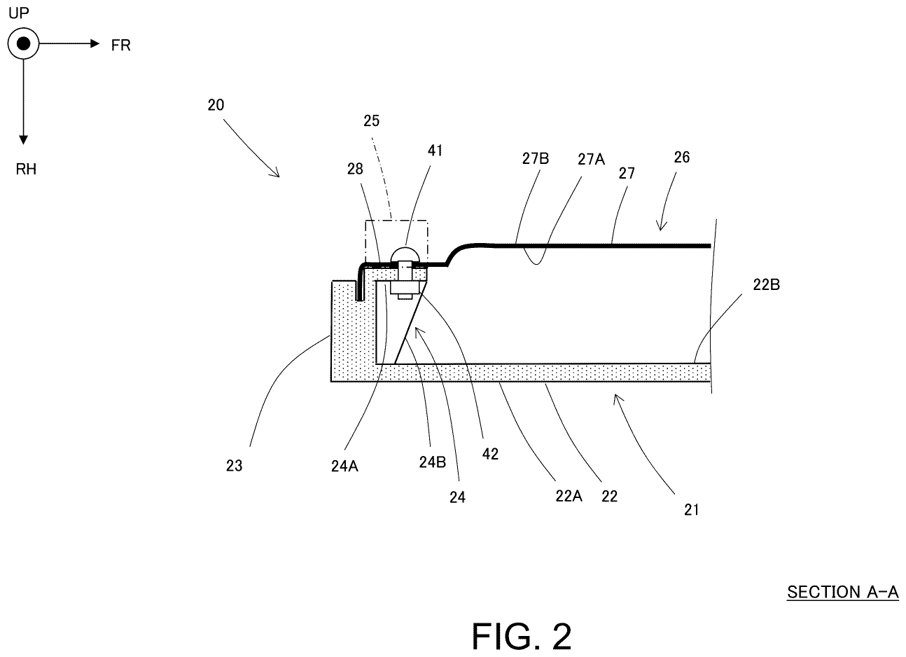

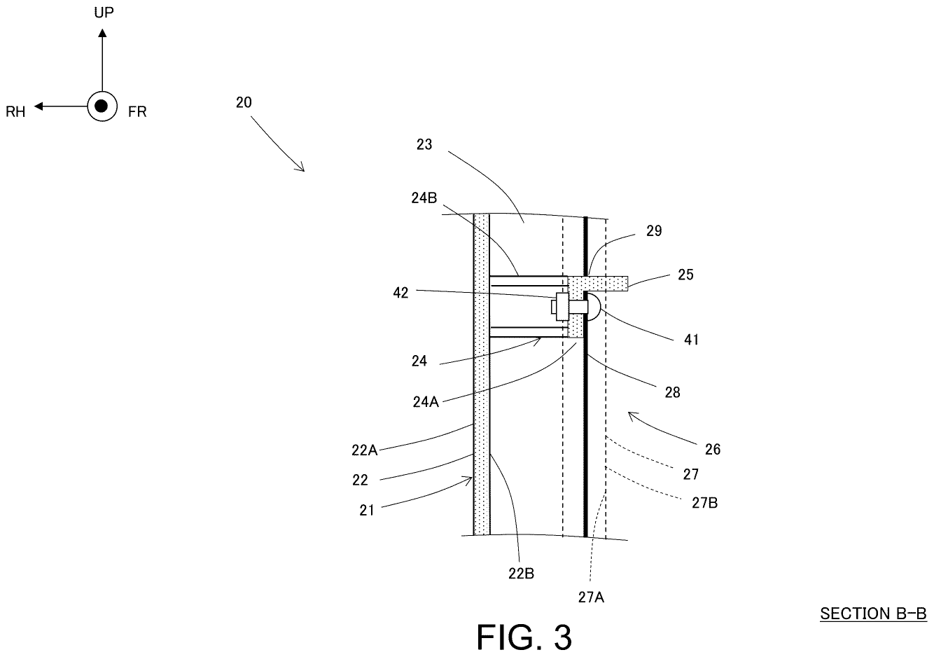

Next, the front door 20 will be described. As shown in FIGS. 1 and 2, the front door 20 is a hinge door whose front end portion is rotatably attached to the body 10 by a hinge and whose rear end portion opens and closes toward the side of the vehicle 100. The front door 20 includes a front door frame 26 made of metal and a front door outer panel 21 made of resin. As shown in FIG. 2, the front door frame 26 is a metal folded plate member, and includes a panel portion 27 and a flange 28 on the outer periphery of the panel portion 27. As shown in FIG. 3, the flange 28 is provided with a hole 29 through which a protector 25 provided on the front door outer panel 21 described later passes. The front door frame 26 may be a cast product of metal such as aluminum.

The front door outer panel 21 made of resin includes a panel portion 22, an outer peripheral portion 23, a bracket 24, and a protector 25. The panel portion 22, the outer peripheral portion 23, the bracket 24, and the protector 25 are integrally molded of resin. The panel portion 22 is a flat plate-shaped portion in which an outer surface 22A constitutes a design surface of the front door 20. The outer peripheral portion 23 is a portion extending toward the vehicle width direction inner side on the outer periphery of the panel portion 22. The bracket 24 is disposed at a corner portion between the outer peripheral portion 23 and the inner surface 22B of the panel portion 22. The bracket 24 includes a flange 24A and a rib 24B. The flange 24A is a plate-like member protruding from the outer peripheral portion 23 toward the central portion of the front door 20. The rib 24B is a trapezoidal plate member that connects the flange 24A, the outer peripheral portion 23, and the inner surface 22B of the panel portion 22. As shown in FIG. 3, the protector 25 is a plate-like member protruding inward in the vehicle width direction from the upper end of the flange 24A.

The flange 24A of the bracket 24 of the front door outer panel 21 is fastened onto the flange 28 of the front door frame 26 by a bolt 41 and a nut 42. Thus, the front door outer panel 21 is attached to the outside of the front door frame 26. At this time, the protector 25 of the front door outer panel 21 penetrates the hole 29 provided in the flange 28 and protrudes to the vehicle width direction inner side of the flange 28 above the bolt 41.

As a result, the protector 25 covers the bolt 41 from above and makes it difficult to access the bolt 41 from above. Further, the protector 25 makes it difficult to specify the position of the bolt 41.

In addition, since the panel portion 22, the outer peripheral portion 23, the bracket 24, and the protector 25 of the front door outer panel 21 are formed by integral molding of resin, access to the bolt 41 can be made difficult with a simple configuration.

The protector 25 protrudes from the upper end of the bracket 24 toward the front door frame 26. Accordingly, since the protector 25 can be disposed in the vicinity of the bolt 41, access to the bolt 41 can be made more difficult.

The bolt 41 is an example of a fastening member, and for example, the front door outer panel 21 may be configured to be attached to the outside of the front door frame 26 by a clip or the like, and the protector 25 may be configured to cover the clip.

In the above description, the protector 25 is provided at the upper end of the bracket 24. For example, the protector 25 may be provided at the upper end, the front end, and the rear end of the bracket 24 so as to cover the upper side, the front side, and the rear side of the bolt 41. In addition, the protector 25 may not be provided on the bracket 24, but may be erected from the inner surface 22B of the panel portion 22.

Next, a rear door 30 which is another example of the vehicle body panel of the embodiment will be described. As shown in FIG. 1, the rear door 30 has the same configuration as that of the front door 20 and includes a rear door frame made of metal (not shown) and a rear outer panel 31 made of resin attached to the outside of the rear door frame. An outer surface 32A of the panel portion 32 of the rear outer panel 31 constitutes a design surface of the rear door 30. The rear outer panel 31 includes a bracket 34 and a protector 35 therein. Similarly to the protector 25 of the front door outer panel 21, the protector 35 protrudes inward in the vehicle width direction above the bolt 41 and covers the bolt 41 from above. This makes it difficult to access the bolt 41 from above.

The front door 20 and the rear door 30, which are embodiments of the vehicle body panel, have been described above. For example, as shown in FIG. 1, a bracket 74 having a structure similar to that of the bracket 24 and a protector 75 having a structure similar to that of the protector 25 may be provided on the front fender panel 11 to make access to the bolt 41 difficult. Similarly, a bracket 76 having the same structure as the bracket 24 and a protector 77 having the same structure as the protector 25 may be provided on the rear fender panel 12 made of resin to make access to the bolt 41 difficult.

Next, a vehicle 101 including a vehicle body panel according to another embodiment will be described with reference to FIGS. 4 to 6. The same parts as those of the vehicle 100 described above with reference to FIGS. 1 to 3 are denoted by the same reference numerals, and description thereof is omitted.

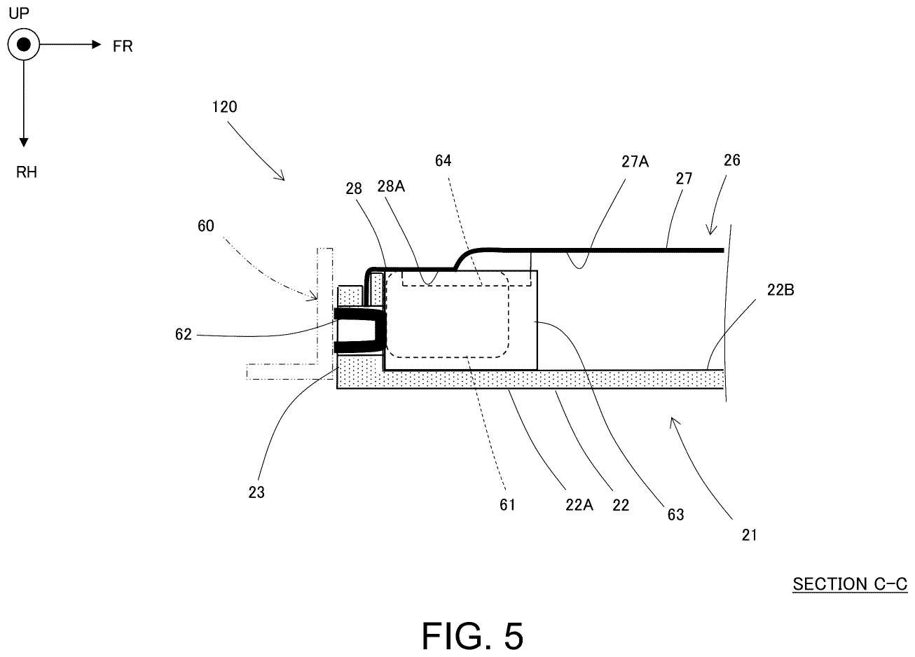

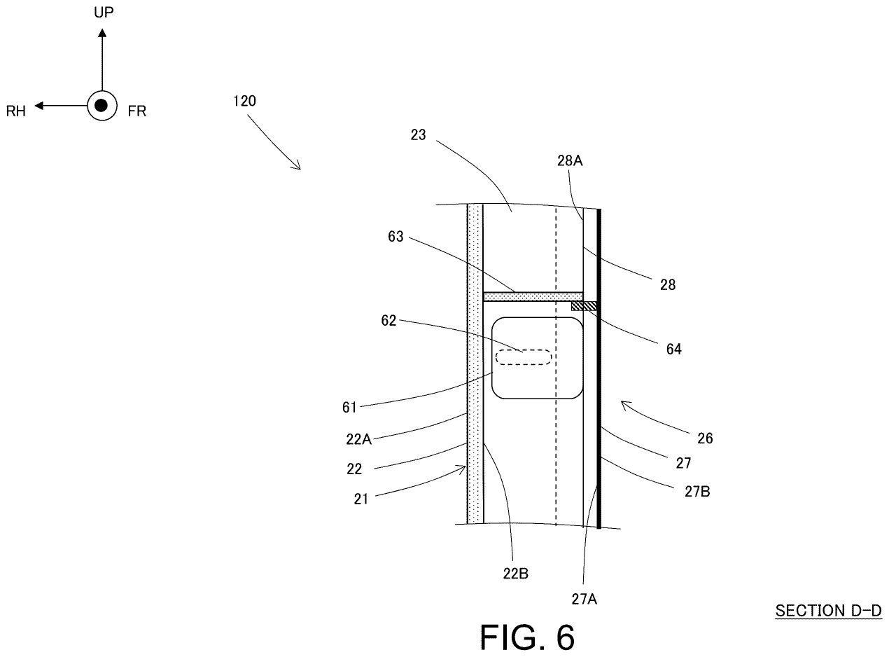

As shown in FIG. 4, the vehicle 101 includes a front door 120 and a rear door 130 which are other embodiments of the vehicle body panel. As shown in FIGS. 5 and 6, the front door 120 includes a protector 25 and a lock protector 63. In the front door 120, a door lock mechanism 61 is attached to a rear portion of a space between the front door outer panel 21 and the front door frame 26. When the front door 120 is closed, a hook (not shown) of the door lock mechanism 61 engages with the striker 62 fixed to the center pillar 60. Thus, the front door 120 engages with the center pillar 60.

As shown in FIG. 6, a lock protector 63 protruding from the inner surface 22B of the front door outer panel 21 toward the front door frame 26 is provided above the door lock mechanism 61 in the vehicle. The lock protector 63 is a plate-shaped member made of resin, and is resin-molded integrally with the front door outer panel 21. A flange 64 that supports an end portion of the lock protector 63 is provided on the outer surface 27A of the panel portion 27 and the outer surface 28A of the flange 28 of the front door frame 26. The panel portion 27 is provided with an inner surface 27B opposite the outer surface 27A. The flange 64 is a rib plate protruding from the outer surfaces 27A and 28A toward the front door outer panel 21.

Similarly, similarly to the front door 120, the rear door 130 is provided with the protector 25 and the lock protector 73 that covers the upper side of the door lock mechanism 61 provided at the rear end portion.

Since the front door 120 and the rear door 130 of the vehicle 101 include the lock protectors 63 and 73 that cover the door lock mechanism 61 from above, it is difficult to access the door lock mechanism 61 from above. In addition, the lock protectors 63 and 73 make it difficult to specify the position of the door lock mechanism 61.

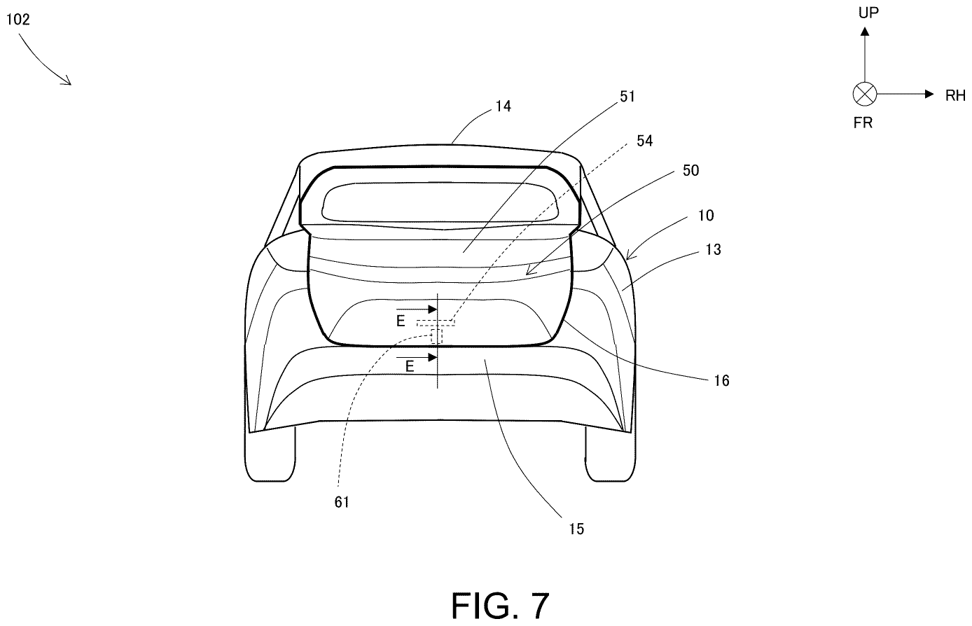

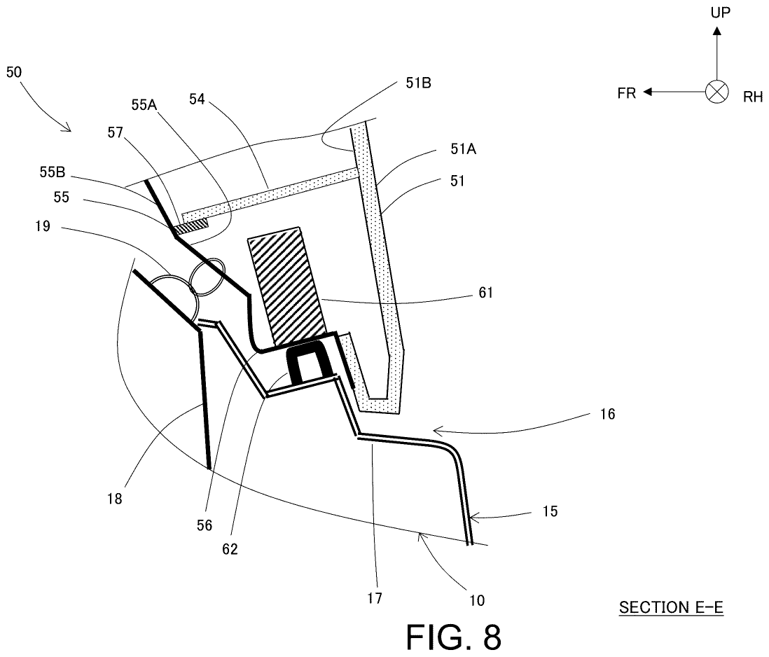

Next, a vehicle 102 including a back door 50, which is another example of the vehicle body panel, will be described. First, the structure of the rear portion of the body 10 of the vehicle 102 will be described with reference to FIGS. 7 and 8.

As shown in FIG. 7, the rear portion of the body 10 of the vehicle 102 is provided with an opening 16 defining upper, lower, left, and right sides by the rear end of the roof panel 14, the upper end of the bumper 15, and the vehicle width direction center ends of the left and right rear side panels 13. A front end portion of the back door 50 is rotatably attached to the roof panel 14 of the body 10 by a hinge, and a lower end portion thereof opens and closes in the vertical direction to open and close the opening 16.

As shown in FIG. 8, a frame portion 17 recessed from the design surface is provided on the inner peripheral portion of the opening 16 of the body 10. The frame portion 17 is provided with a striker 62. A rear inner panel 18 made of metal is provided inside the frame portion 17. The rear inner panel 18 is provided with a seal rubber 19. An inner opening (not shown) communicating with the inside of the rear compartment (not shown) is provided inside the seal rubber 19.

Next, the back door 50 will be described. As shown in FIGS. 7 and 8, the back door 50 includes a back door frame 55 made of metal and a back door outer panel 51 made of resin. The back door frame 55 may be a folded plate member made of metal, or may be a cast product made of metal such as aluminum.

A front end portion of the back door frame 55 is rotatably connected to the roof panel 14 by a hinge. A door lock mechanism 61 for fixing the back door 50 to the body 10 is provided on the outer edge portion 56 of the lower end of the back door frame 55. When the back door 50 is closed, the hook of the door lock mechanism 61 engages with the striker 62 fixed to the frame portion 17. Thus, the back door 50 engages with the frame portion 17 and is supported by the frame portion 17.

The outer surface 51A of the back door outer panel 51 constitutes a design surface of the back door 50. The back door outer panel 51 is provided with a lock protector 54 that extends from an inner surface 51B facing the back door frame 55 toward the back door frame 55 and covers an upper portion of the door lock mechanism 61. The lock protector 54 is a plate-shaped member made of resin, and is resin-molded integrally with the back door outer panel 51.

An outer surface 55A of the back door frame 55 is provided with a flange 57 that supports an end portion of the lock protector 54. The back door frame 55 is provided with an inner surface 55B opposite the outer surface 55A. The flange 57 is a rib plate protruding from the outer surface 55A toward the back door outer panel 51.

As described above, since the back door 50 includes the lock protector 54 that covers the upper portion of the door lock mechanism 61, it is difficult to access the door lock mechanism 61 from above. In addition, the lock protector 54 makes it difficult to specify the position of the door lock mechanism 61.

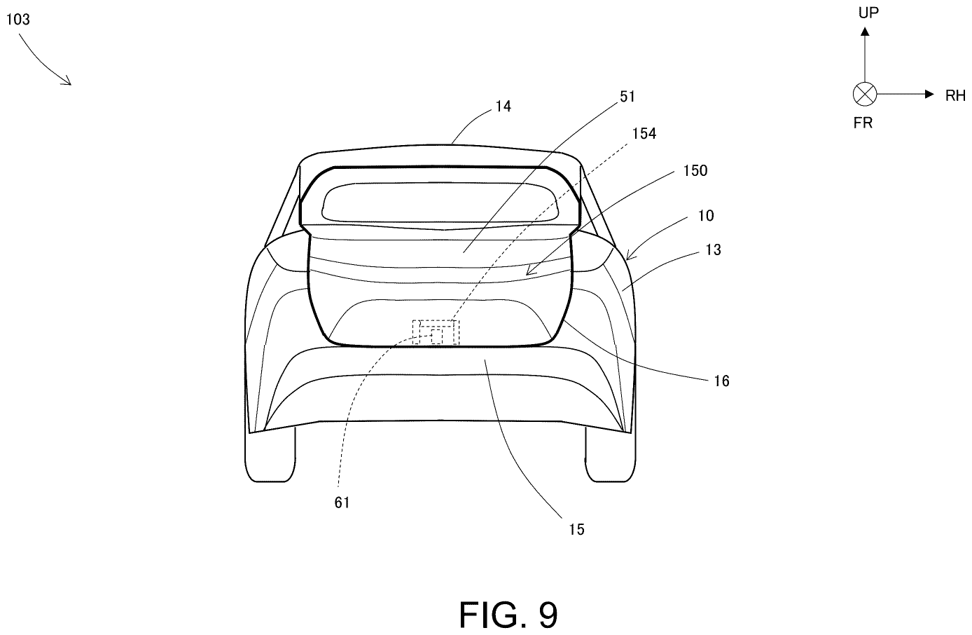

Next, a vehicle 103 including a back door 150, which is a vehicle body panel according to another embodiment, will be described with reference to FIG. 9. As shown in FIG. 7, the back door 150 of the vehicle 103 is provided with a lock protector 154 having a groove-shaped cross section covering the upper side and the left and right sides of the door lock mechanism 61.

This makes it difficult to access the door lock mechanism 61 from the upper, lower, left, and right sides.

1. A vehicle body panel structure comprising:
a frame made of metal;
an outer panel made of resin and attached to an outer side of the frame;
a fastening member that fastens the outer panel to the frame; and
a protector that covers at least a part of the fastening member, wherein
the protector is provided on the outer panel, passes through the frame to protrude from an inner side of the frame, and covers, at the inner side of the frame, at least a part of the fastening member.

2. The vehicle body panel structure according to claim 1, wherein
the outer panel includes a bracket fastened to the frame by the fastening member,
the protector protrudes from the bracket toward the frame, and
the frame includes a hole through which the protector passes.

3. The vehicle body panel structure according to claim 2, wherein
the bracket and the protector are integrally molded with the outer panel.

4. The vehicle body panel structure according to claim 1, wherein
the frame is a door frame,
the outer panel is a door outer panel,
the vehicle body panel structure further comprises a door lock mechanism disposed in a space between the door frame and the door outer panel, and
the door outer panel has a lock protector that extends from a surface facing the door frame toward the door frame and covers at least a part of the door lock mechanism.

5. The vehicle body panel structure according to claim 2, wherein
the frame is a door frame,
the outer panel is a door outer panel,
the vehicle body panel structure further comprises a door lock mechanism disposed in a space between the door frame and the door outer panel, and
the door outer panel has a lock protector that extends from a surface facing the door frame toward the door frame and covers at least a part of the door lock mechanism.

6. The vehicle body panel structure according to claim 3, wherein
the frame is a door frame,
the outer panel is a door outer panel,
the vehicle body panel structure further comprises a door lock mechanism disposed in a space between the door frame and the door outer panel, and
the door outer panel has a lock protector that extends from a surface facing the door frame toward the door frame and covers at least a part of the door lock mechanism.

7. The vehicle body panel structure according to claim 4, wherein
the door frame includes a flange protruding toward the door outer panel from a surface facing the door outer panel and configured to support an end portion of the lock protector.

8. The vehicle body panel structure according to claim 5, wherein
the door frame includes a flange protruding toward the door outer panel from a surface facing the door outer panel and configured to support an end portion of the lock protector.

9. The vehicle body panel structure according to claim 6, wherein
the door frame includes a flange protruding toward the door outer panel from a surface facing the door outer panel and configured to support an end portion of the lock protector.

10. A vehicle body panel structure comprising:
a door frame made of metal;
a door outer panel made of resin and attached to an outer side of the door frame; and
a door lock mechanism disposed in a space between the door frame and the door outer panel, wherein
the door outer panel has a lock protector that extends from a surface facing the door frame toward the door frame and covers at least a part of the door lock mechanism.

11. The vehicle body panel structure according to claim 10, wherein
the door frame comprises a flange protruding from a surface facing the door outer panel toward the door outer panel and configured to support an end portion of the lock protector.
